(19) United States
(12) Patent Application Publication
(10) Pub. No.: US 2005/0207603 A1
(43) Pub. Date: Sep. 22, 2005

(54) Speaker

(75) Inventor: Kin Man Tse, Kwai Chung (HK)

Correspondence Address: LEYDIG VOIT & MAYER, LTD, 700 THIRTEENTH ST. NW, SUITE 300, WASHINGTON, DC, 20005-3960, US

(73) Assignee: Plastoform Industries Ltd., Kwai Chung (HK)

(21) Appl. No.: 11/074,690

(22) Filed: Mar. 9, 2005

(30) Foreign Application Priority Data
Mar. 17, 2004 (GB) 0405986.1

(51) Int. Cl. H04R 25/00

(52) U.S. Cl. 381/351; 381/345

(57) ABSTRACT

A speaker includes a main housing, a pair of extension housings extending telescopically from respective opposed ends of the main housing and each having two speaker drivers therein that are concealed by the main housing when the extension housings are retracted and exposed when the extension housings are extended.

The present invention relates to speakers. More particularly, although not exclusively, the invention relates to a speaker for use with personal computers and for sitting upon a desk in front of and below a display monitor.

### BACKGROUND OF THE INVENTION

It is known to provide acoustic speakers for reproducing sounds from a personal computer. Some speakers are built into the display monitor and others are provided as separate left and right speakers to be positioned at either side of the display monitor.

Where desk space is at a premium, there is often little space at either side of a display monitor at which separate speakers can be located. Modern computer monitors come in a variety of sizes and aspect ratios. The modern 16:9 monitors for example are somewhat wider than standard 15 inch monitors.

There is often unused desk space between the back of the keyboard and the front of the display monitor in which a wide stereo speaker could be placed conveniently upon the desk. Aesthetically, such a speaker ought to approximate the width of the monitor, yet customers don't necessarily know the precise physical width of their monitor when they go out to purchase speakers.

### OBJECT OF THE INVENTION

It is an object of the present invention to overcome or substantially ameliorate the above disadvantages and/or more generally to provide an improved unitary speaker of adjustable width.

### SUMMARY OF THE INVENTION

According to the invention, there is provided a speaker comprising a main housing, and an extension housing fitted telescopically at an end of the main housing. The extension housing has a speaker driver therein that is concealed by the main housing when the extension housing is retracted and exposed when the extension housing is extended.

In a preferred embodiment, the speaker comprises a pair of said extension housings extendable telescopically from respective opposed ends of the main housing and each having a speaker driver therein that is concealed by the main housing when the extension housing is retracted and exposed when the extension housing is extended.

More preferably, the extension housings each comprise a pair of speaker drivers.

It is preferred that the speaker further comprises a seal between each extension housing and the main housing.

It is preferred that the main housing is divided internally into separate chambers with which the respective speaker driver or drivers of each extension housing communicate.

Preferably, each extension housing includes an annular support at its rear end for engaging proximal end of the main housing to support the extension housing when it is fully extended.

More preferably, the annular support comprises a pair of spaced apart rings.

It is preferred that each extension housing comprises a base reflex port.

In one preferred embodiment, the speaker includes a base stand on which the main housing is pivotally supported.

In another preferred embodiment, the speaker includes a base stand on which the main housing is slidably supported.

### BRIEF DESCRIPTION OF DRAWINGS

The invention will now be more particularly described, by way of example only, with reference to the accompanying drawings, in which:

FIG. 1 is a schematic perspective illustration of an embodiment of a speaker in accordance with the invention, having its speaker drivers in an extended configuration;

FIG. 2 is a schematic front elevation of the speaker of FIG. 1 in the extended configuration;

FIG. 3 is a schematic inverted plan view of the speaker of FIG. 1 in the extended configuration;

FIG. 4 is a schematic inverted plan view of the speaker of FIG. 1 with the speaker drivers in a retracted configuration;

FIG. 5 is a schematic cross-sectional plan view of the speaker of FIG. 1 with the speaker drivers in the extended configuration;

FIG. 6 is a schematic cross-sectional plan view of the speaker of FIG. 4 with the speaker drivers in the retracted configuration;

FIG. 7 is a schematic end elevation of the speaker of FIG. 1, having its body pivoted upwardly from a stand thereof for operation;

FIG. 8 is a schematic end elevation of the speaker of FIG. 7, with its body and stand pivoted close together for storage;

FIG. 9 is a schematic end elevation of the speaker of FIG. 1, incorporating a different stand and with its body adjusted to a high position on the stand for operation; and

FIG. 10 is a schematic end elevation of the speaker of FIG. 9, with its body adjusted to a low position on the stand especially suitable for storage.

### DETAILED DESCRIPTION OF PREFERRED EMBODIMENT

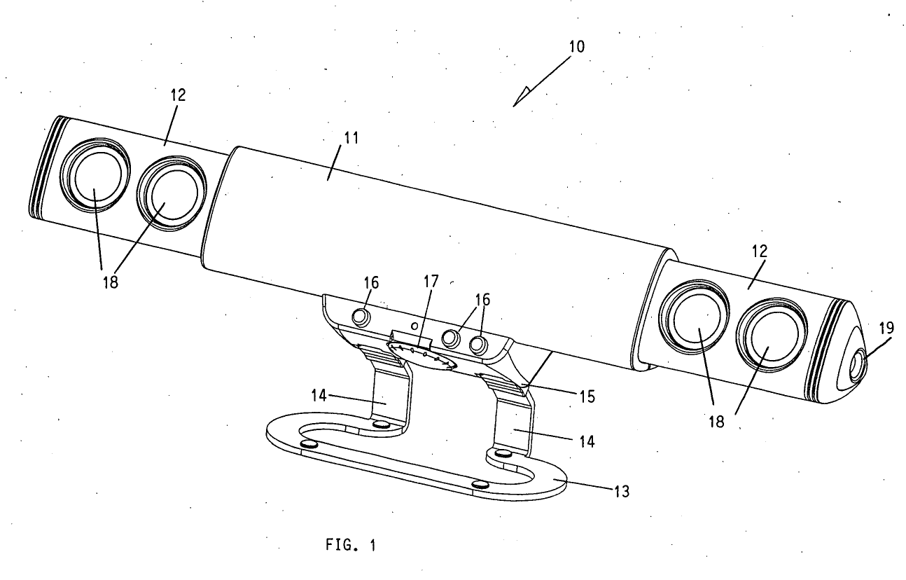

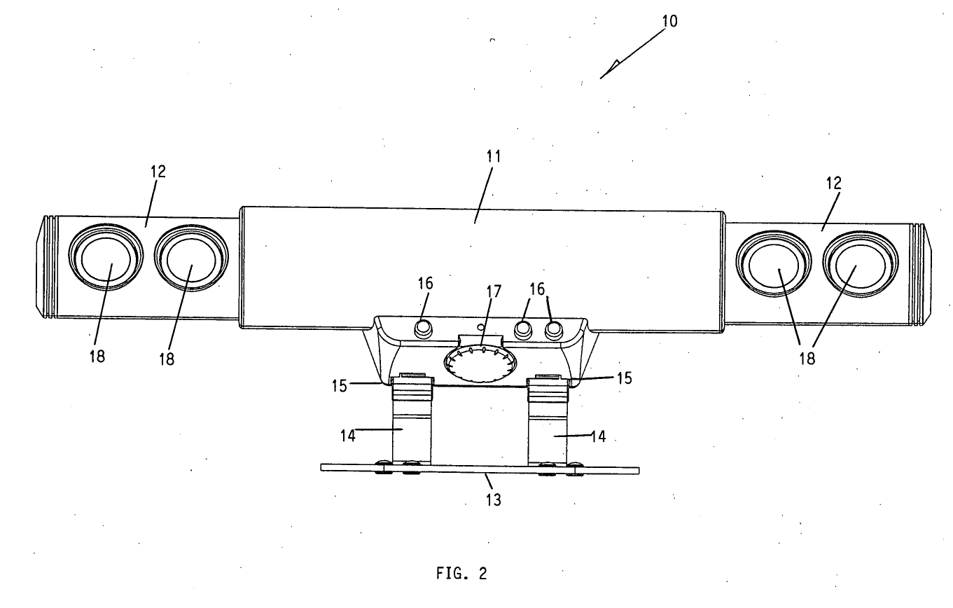

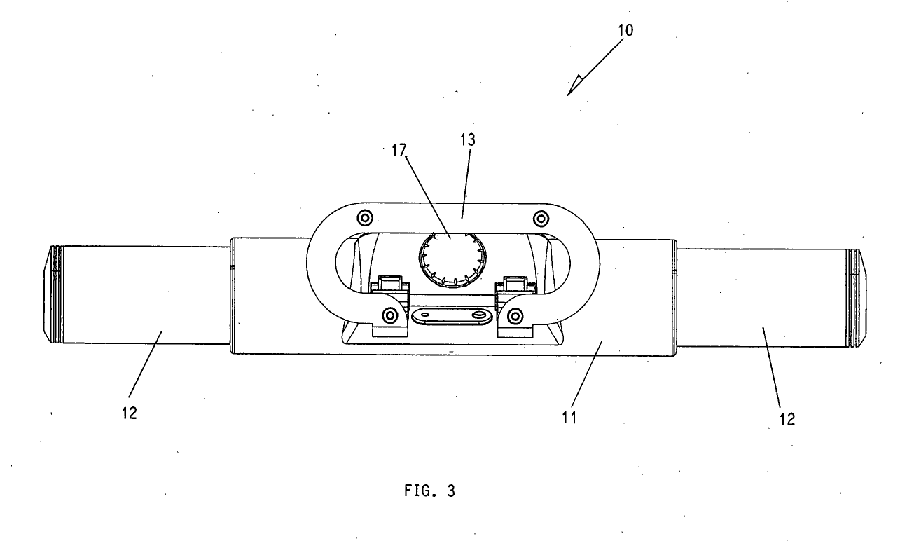

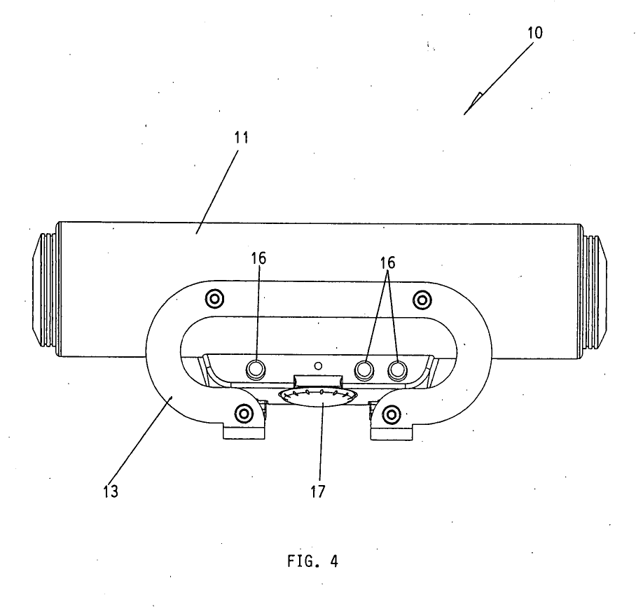

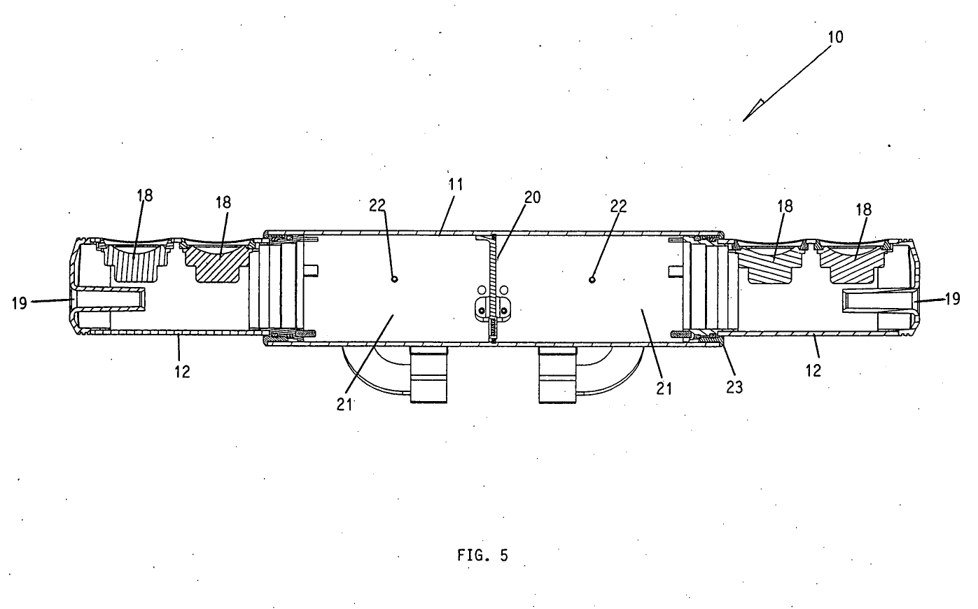

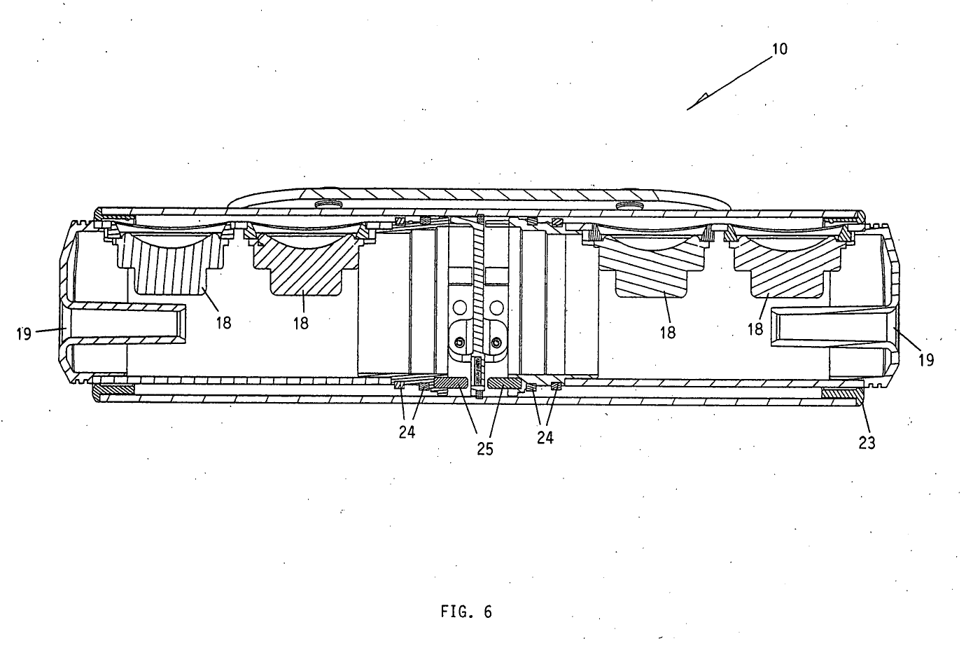

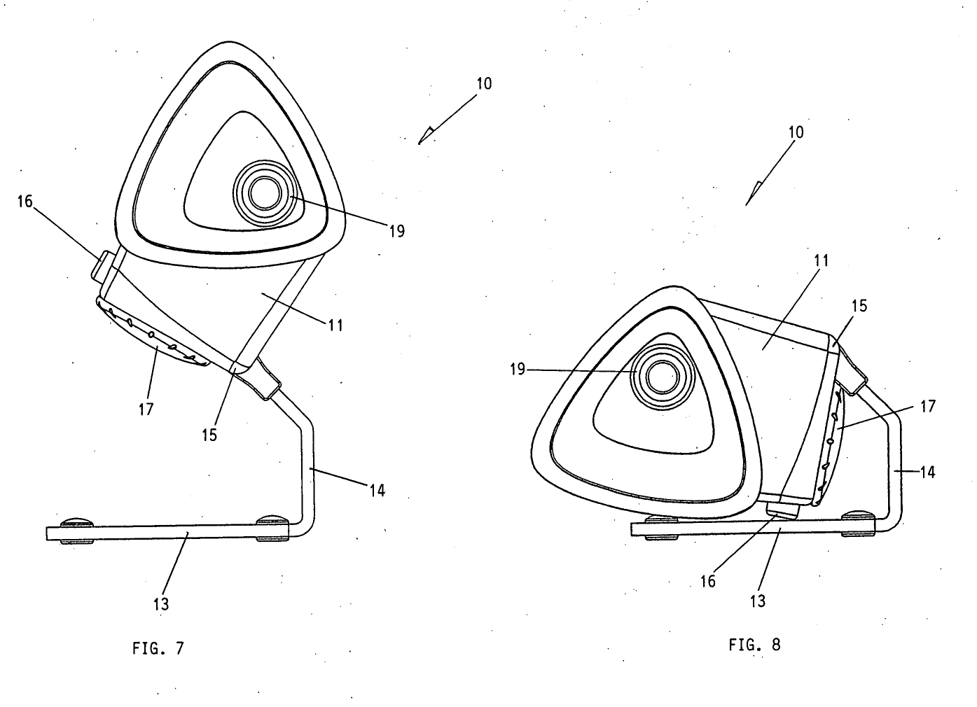

Referring initially to FIGS. 1 to 8 of the drawings, there is shown a speaker 10 embodying the invention, which is typically fabricated substantially of moulded plastics and/or cast and/or machined aluminium for example. The speaker 10 has a horizontal tubular main housing 11 and a pair of telescopic housing extensions 12 projecting from within opposite left and right ends thereof. The main housing 11 is supported upon a base stand 13, which has a pair of legs 14 that is attached pivotally at 15 to the main housing 11. The stand 13 may be extended to support the speaker 10 for operation, or pivoted close to the main housing 11 for storage.

Control switches 16 and a volume-adjustment dial 17 are provided upon the main housing 11. An internal amplifier may be provided for a low-level signal input, or the volume dial 17 may be attached to a passive variable resistor for a higher-level signal input.

Mounted within each extension housing 12 is a pair of speaker drivers 18. In the preferred embodiment four separate speaker drivers 18 are provided, with two for each of the left and right channels in a stereo arrangement.

Each extension housing 12 comprises a bass reflex port 19 through its outer end wall. A central partition 20 divides the interior of the main housing 11 into a pair of acoustic chambers 21. Each acoustic chamber 21 has an internal volume that extends to and communicates with that of the corresponding extension housing 12. An electrical cable extends through holes 22 in the main housing 11 to each of the speaker drivers 18. A certain amount of slackness should be provided in each cable to allow the extension housings 12 to move in and out whilst maintaining an electrical signal path to each speaker driver 18.

An annular seal member 23 is provided at each end of the main housing 11. The seal member 23 may be made of a slightly resilient plastics material and serves to maintain a substantially tight seal between the main housing 11 and the external sliding surface of the extension housings 12. The speaker drivers 18 are so positioned as not to clash with the seal member 23 when the extension housings 12 are retracted or extended. Regardless of the extended position of the extension housings 12, the action of the seal 23 ensures that the only communication of air between the acoustic chambers 21 and the environment is via the bass reflex ports 19.

To maintain the extension housings 12 in a cantilevered suspended configuration when fully extended from the main housing 11, a pair of spaced apart support rings 24 is provided at the rear, proximal end of each extension housing 12. These support rings 24 do not engage with the inner surface of the main housing 12. The support rings 24 engage with the seal member 23 at two circles.

More specifically, the outer/smaller support ring 24 engages the inner surface of the seal member 23 and the inner/wider support ring 24 engages the rear edge of the seal member 23 to define the maximum telescoped extent of each extension housing 12 by providing a stopper. The two-circle engagement provides a firm and stable cantilevered support for each extension housing 12 loaded by the heavy speaker drivers 18.

At the innermost end of each extension housing 12, there is also provided a buffer 25 that bears against the partition 20 when the extension housing 12 is fully retracted.

In use, the extension housings 12 need not be fully extended from the main housing 11. Instead, the extension housings 12 can be left at any intermediate position so that the overall length of the speaker 10 approximates the width of the displaying monitor before which the speaker 10 is placed for operation.

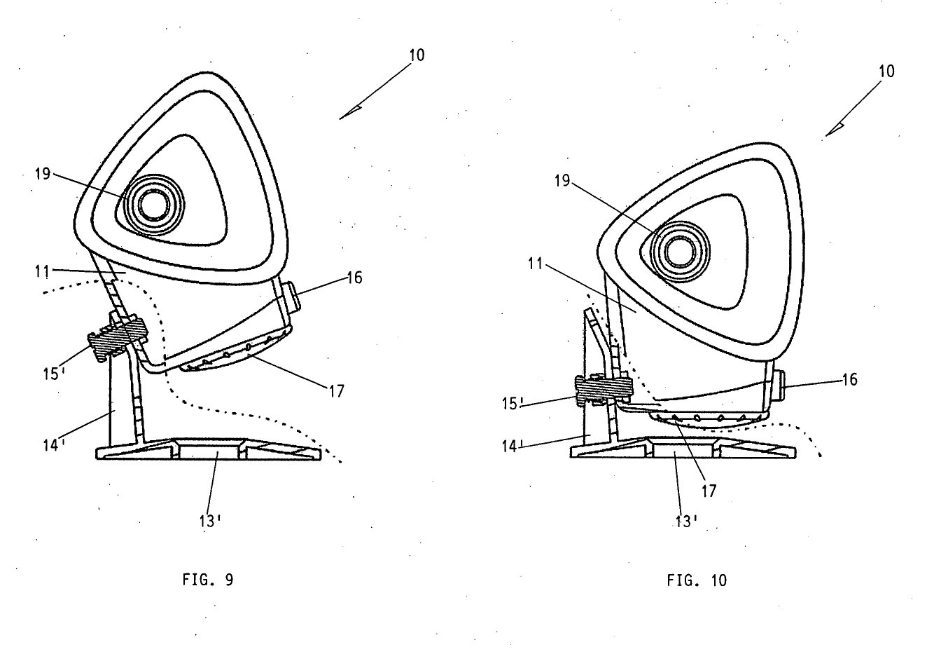

FIGS. 9 and 10 show the same speaker 10 of the subject invention but it incorporates a different base stand 13′. This stand 13′ has a pair of legs 14′ each including a slot through which a screw 15′ extends and engages the back of the main housing 11. The screws 15′ may be loosened to allow the main housing 11 to slide along the slot for adjustment between a high position (for operation) and a low position (especially suitable for storage) on the stand 13′, and then tightened to fix the main housing 11.

It should be appreciated that modifications and alterations obvious to those skilled in the art are not to be considered as beyond the scope of the present invention. For example, the speaker drivers might be connected in a monaural configuration for use as a centre-channel speaker in a home cinema set-up.

1. A speaker comprising:
a main housing, and
an extension housing fitted telescopically at an end of the main housing and having a speaker driver therein that is concealed by the main housing when the extension housing is retracted and exposed when the extension housing is extended.

2. The speaker as claimed in claim 1, comprising a pair of said extension housings extendable telescopically from respective opposed ends of the main housing and each having a speaker driver therein that is concealed by the main housing when the extension housing is retracted and exposed when the extension housing is extended.

3. The speaker as claimed in claim 2, wherein the extension housings each comprise a pair of speaker drivers.

4. The speaker as claimed in claim 2, further comprising a seal between each extension housing and the main housing.

5. The speaker as claimed in claim 2, wherein the main housing is divided internally into separate chambers with which the respective speaker driver or drivers of each extension housing communicate.

6. The speaker as claimed in claim 2, wherein each extension housing includes an annular support at its rear end for engaging proximal end of the main housing to support the extension housing when it is fully extended.

7. The speaker as claimed in claim 6, wherein the annular support comprises a pair of spaced apart rings.

8. The speaker as claimed in claim 2, wherein each extension housing comprises a base reflex port.

9. The speaker as claimed in claim 1, including a base stand on which the main housing is pivotally supported.

10. The speaker as claimed in claim 1, including a base stand on which the main housing is slidably supported.
